(19) United States
(12) Patent Application Publication
(10) Pub. No.: US 2003/0013804 A1
(43) Pub. Date: Jan. 16, 2003

(54) Novel phenol-aldehyde/wax emulsion adhesive

(76) Inventors: Earl K. Phillips, Diboll, TX (US); Richard Stratton, Diboll, TX (US); Dale Leeper, Diboll, TX (US)

Correspondence Address: STEVENS, DAVIS, MILLER & MOSHER, L.L.P., 1615 L Street, N.W., Suite 850, Washington, DC, 20036, US

(21) Appl. No.: 10/170,230

(22) Filed: Jun. 13, 2002

Related U.S. Application Data
(60) Provisional application No. 60/298,125, filed on Jun. 15, 2001.

(51) Int. Cl. C08K 3/00; C08K 5/01

(52) U.S. Cl. 524/594; 524/487

(57) ABSTRACT

Stable emulsions for use in the field of adhesives have been prepared using a non lignin, nonionic surfactant in phenol-aldehyde/wax emulsions. The adhesives have utility for binding wood particles into a unitary mass such as used in the strandboard, chipboard, particles board, plywood, laminated veneer lumber and high and medium density fiberboard industries and exhibit storage stability.

### CROSS-REFERENCE TO RELATED APPLICATIONS

This application is a U.S. Non-Provisional Application claiming priority of U.S. Provisional Patent Application Serial No. 60/298,125, filed Jun. 15, 2001.

### BACKGROUND OF THE INVENTION

1. Field of the Invention

This invention relates generally to the field of adhesives and, more specifically, to a nonionic surfactant for producing stable emulsions in a phenol-aldehyde/wax emulsion environment.

2. Description of the Related Art

The use of adhesives, especially phenol-aldehyde resole resins, to bind wood particles into a unitary mass is generally well known. Many useful wood products, including oriented strandboard (OSB), chipboard or particle board can be made by coating the wood particles with a phenol-aldehyde resin, and consolidating the particles, usually under heat and pressure, into a unitary mass.

However, the need has been recognized to impart water resistance to such wood products, such as by the incorporation of a wax into the product. However, wax does not form a stable emulsion in the presence of a phenol-aldehyde resin.

Recently, it has been discovered that phenol-aldehyde resins can be made into a stable emulsion if an anionic emulsifier, such as a lignosulfonate, e.g., sodium lignosulfonate, is added to the blend of wax and phenol-aldehyde. This anionic emulsifier is shear sensitive, as well as resin sensitive. Furthermore, anionic emulsifiers do not exhibit storage stability beyond a short term, e.g., on the order of one day.

The first attempt to solve long-term stability problems of a phenol-aldehyde/wax emulsion was to modify the pH of the phenol-aldehyde, wax emulsion by forming an adjusted pH resin of between 9 and 12, adjusting the pH of the wax emulsion to within 1 pH unit of the resin, and combining the same, with mixing, at a temperature of the resin above 40° C.; See, U.S. Pat. No. 6,132,885.

Further attempts to solve the problem of phenol-aldehyde, wax emulsion stability can be found in U.S. Pat. No. 6,028,133, which incorporates a cationic surfactant, such as an alkali salt of sulfite or bisulfite, into a phenolic resin so as to obtain a resin with anionic character. However, this process also proved not to be fully effective as it was both resin and wax sensitive. The disclosures of the above-mentioned U.S. Patents are herein incorporated by reference in their entirety.

However, despite these attempts to provide a stable emulsion, there continues to be a need for a phenol-aldehyde wax emulsion that is much more shear stable than a lignin based emulsion and which provides long term stability, nor use the ionic surfactants of the above-mentioned systems with their attendant disadvantages.

### SUMMARY OF THE INVENTION

The present inventors have developed non-lignin based and non-ionic emulsion systems that provide stability to phenol-aldehyde, wax emulsions.

The present invention permits the use of a wider variety of phenolic resins than that permitted in the aforementioned U.S. Patents, as well as a wider variety of raw waxes, with improved shear stability.

These and other attributes of the invention will be seen in connection with the following detailed description of the preferred embodiments.

### DETAILED DESCRIPTION OF THE PREFERRED EMBODIMENTS

The various resins suitable for use in the invention are termed phenol-aldehydes which is meant to describe thermosetting resins formed from a phenol or phenol contributing substance and a methylene donor, such as formaldehyde.

Generally, the phenol or phenol contributing substance includes phenol, resorcinol, hydroquinone, cresols and other phenol derivatives, such as xylenols, catechol, cresylic acids, urea, melamine and combinations thereof.

The methylene donor can be formaldehyde, paraformaldehyde, formalin, acetaldehyde, propionaldehyde, and similar substances.

Suitable resins include phenol-formaldehyde, phenol-resorcinol-formaldehyde, urea-melamine formaldehyde, melamine-formaldehyde, phenol-melamine-formaldehyde, melamine-urea-resorcinol formaldehyde, resorcinol-formaldehyde and combinations thereof.

The wax emulsion (also known as a paraffin emulsion) can be formed from a variety of naturally occurring waxes, such as slack wax, shale wax, poppy wax, honey wax and Chinese wax or from synthetic waxes such as esters of fatty acids, such as n-octadecyl palmitate and cetyl stearate. Slack wax, a byproduct of petroleum refining, is preferred.

Typical formulations can be seen in the following exemplary compositions. All percentages are in parts by weight unless otherwise indicated.

### EXAMPLE 1

| | |
|---|---|
| Raw Material | % |

| | | |
|---|---|---|
| 1) | 100% phenol | 25.0 |
| 2) | Water | 15.28 |
| 3) | 50% sodium hydroxide | 2.50 |
| 4) | 50% formaldehyde | 31.92 |
| 5) | 50% sodium hydroxide | 6.00 |
| 6) | 50% sodium hydroxide | 3.50 |
| 7) | Urea | 2.50 |
| 8) | Cascowax EW-58NI | 13.30 |

1) Charge phenol (1), water (2) and sodium hydroxide (3). Exotherm to 55-60° C.

2) At >55° C., program formaldehyde (4) over 35-45 minutes while exotherming to 81° C.

3) Hold at 81° C. for 10 minutes after formaldehyde is in

4) Charge sodium hydroxide (5) over 8-10 minutes while exotherming to 92° C.

5) Condense at 92° C. to a Gardner viscosity “D/E” of about 110 cps.

6) At “D/E” cool to 81° C. and charge sodium hydroxide (6)

7) Hold at 81° C. to “M/N” viscosity

8) Cool to 75° C. and react to a Gardner viscosity “W/X” of about 1180 cps.

9) At “W/X” cool to 70° C. and charge Urea. Let mix 5-10 minutes

10) Charge EW-58NI wax emulsion between 63 and 65° C.

11) Cool to shipping or storage temp.

Solids=49-51%

Alkalinity=5.8-6.2%

100° C. Gel time=30-34 minutes

Viscosity=400-600 cps.

In the foregoing example, “Cascowax EW58NI” is the description for a non-ionic wax emulsion formed of the following composition.

### EXAMPLE 2

| | |
|---|---|
| Slack wax (paraffin) | 53.22% |
| Protachem SG Blend | 4.68% |
| Water | 42.00% |
| Nopco NXZ | 0.10% |

The emulsifier, Protachem SG Blend, is a blend of POE (20) Stearyl Alcohol (CAS #9005-00-0) and Glyceryl Monostearate (CAS #123-94-4). The wax emulsion is made in the same process used for our other wax emulsions, with the new emulsifier. This produces a non-ionic emulsion that is stable when mixed with phenolic resin. The Nopco NXZ is a defoamer, one of several that could be used.

Although we have described the phenol-aldehyde/wax emulsion as providing utility for forming OSB or other particle board, the adhesive is not to be construed as so limited. The adhesive of the invention has general utility for any lignocellulose based substrate such as plywood, laminated veneer lumber (LVL), high density fiber board (HDF) and medium density fiber board (MDF) and other composites.

We claim:

1. An emulsion of a phenol-aldehyde and wax comprising:
phenol-aldehyde, wax; and
an emulsion stabilizing effective amount of a non-ionic surfactant.

2. The emulsion of claim 1, wherein the non-ionic surfactant comprises polyoxyethylene (POE), stearyl alcohol and glyceral monostearate.

3. The emulsion of claim 1, further comprising an aqueous portion.

4. The emulsion of claim 3, wherein the aqueous portion comprises water and at least one component selected from the group consisting of a defoamer and pH regulating agents.

5. The emulsion of claim 1, wherein the phenol-aldehyde consists of at least one material selected from the group consisting of phenol-formaldehyde, phenol-resorcinol-formaldehyde, urea-melamine formaldehyde, melamine-formaldehyde, phenol-melamine-formaldehye, melamine-urea-resorcinol formaldehyde, and resorcinol-formaldehyde.

6. The emulsion of claim 5, wherein the wax is selected from natural and synthetic waxes.

7. The emulsion of claim 6, wherein the wax is one selected from the group consisting of slack wax, shale wax, poppy wax, honey wax, Chinese wax, and esters of fatty acids.

8. An adhesive comprising the emulsion of claim 1.

9. Bonded wood products comprising particles of a lignocellulosic material bond together with the adhesive of claim 8.

10. The bonded wood products of claim 9, wherein the wood products are at least one selected from the group consisting of oriented strandboard, particle board, chipboard, laminated veneer lumber, plywood, high density fiberboard and medium density fiberboard.

11. A method of stabilizing a phenol-aldehyde/wax emulsion, said method comprising:
combining a non-ionic surfactant with a phenol-aldehyde and wax to form a stabilized phenol-aldehyde/wax emulsion.

12. The method of claim 11, wherein the non-ionic surfactant comprises polyoxyethylene (POE), stearyl alcohol and glyceryl monostearate.

13. The method of claim 11, wherein the phenol-aldehyde is at least one selected from the group consisting of phenol-formaldehyde, phenol-resorcinol-formaldehyde, urea-melamine formaldehyde, melamine-formaldehyde, phenol-melamine-formaldehyde, melamine-urea-resorcinol formaldehyde, and resorcinol-formaldehyde.

14. The method of claim 13, wherein the wax is a natural or synthetic wax.

15. The method of claim 14, wherein the wax is at least one selected from the group consisting of slack wax, shale wax, poppy wax, honey wax, Chinese wax, and esters of fatty acids.

16. The method of claim 13, wherein the wax is slack wax.

17. The method of claim 11, further comprising binding wood particles together with an adhesive formed from the stabilized emulsion.

18. The method of claim 17, wherein the wood particles are formed into at least one product selected from the group consisting of oriented strandboard, particle board, chipboard, laminated veneer lumber, plywood, high density fiberboard and medium density fiberboard.

19. The emulsion of claim 5, wherein the wax is slack wax.

20. Bonded wood products made by the method of claim 17.
